(19) United States
(12) Patent Application Publication
(10) Pub. No.: US 2013/0106020 A1
(43) Pub. Date: May 2, 2013

(54) Manufacture process for heat resistant wear parts carbon brushes & brake pads ASTM preform slurry carbon & 2.5 phase extrusion die cast design for super alloys.

(71) Applicant: Robert Richard Matthews, New York, NY (US)

(72) Inventor: Robert Richard Matthews, New York, NY (US)

(21) Appl. No.: 13/284,935

(22) Filed: Nov. 2, 2011

(51) Int. Cl. B29C 39/00; B22D 17/00; B28B 7/00; B29C 33/00; B82Y 30/00

(52) U.S. Cl. 264/299; 106/38.2; 249/187.1; 164/284; 977/700; 977/742

(57) ABSTRACT

The Variable Hydraulic Preform Slurry Electrolyte Extrusion Carbon and Carbon Nanotube CNTs High Heat Wear Resistant Parts Press FIG. 1 is the center of this utility patent application to manufacture process preform slurry electrolyte extrusion Carbon and Carbon Nanotube CNTs high heat wear resistant parts electronic brushes for electric motors, alternators, generators & aerospace, automotive, transportation brake pads & preform slurry extrusion Carbon and Carbon Nanotube CNTs high heat wear resistant parts precision casting molds for the manufacture process of 2.5 phase extrusion die cast design and precision casting of foundry fill for Super Alloy high wear resistant parts bearings, housings, casings, airframe, flight controls, turbine blades ETC.

The Variable Hydraulic Preform Slurry Electrolyte Extrusion Carbon and Carbon Nanotube CNTs High Heat Wear Resistant Parts Press FIG. 1 Numbers 1 to 18 is the center of this utility patent application to manufacture process preform slurry electrolyte extrusion Carbon and Carbon Nanotube CNTs high heat wear resistant parts electronic brushes for electric motors, alternators, generators & aerospace, automotive, transportation brake pads & preform slurry extrusion Carbon and Carbon Nanotube CNTs high heat wear resistant parts precision casting molds for the manufacture process of 2.5 phase extrusion die cast design and foundry fill of Super Alloy high wear resistant parts bearings, housings, casings, airframe, flight controls, turbine blades ETC.

### BACKGROUND OF THE INVENTION

Global warming and growing concerns of Greenhouse gas emissions from our dependency on fossil fuels are creating real demand and awareness for an electric alternative and improvements to existing technology is fast on the move. A few technological developments of collecting and manufacturing carbon and Carbon Nanotube CNTs improve upon our existing technological structure. Applying general science utilization of preform technology The Variable Hydraulic Preform Slurry Electrolyte Extrusion Carbon and Carbon Nanotube CNTs High Heat Wear Resistant Parts Press with manufactured Carbon and Carbon Nanotube CNTs resources in slurry electrolyte form facilitates the creation of the manufacture process of preform slurry electrolyte extrusion Carbon and Carbon Nanotube CNTs high heat wear resistant parts.

### BRIEF SUMMARY OF THE INVENTION

Scientific utilization of preform technology The Variable Hydraulic Preform Slurry Electrolyte Extrusion Carbon and Carbon Nanotube CNTs High Heat Wear Resistant Parts Press FIG. 1 with manufactured Carbon and Carbon Nanotube CNTs resources in slurry electrolyte form accelerates the manufacture process of high heat wear resistant parts electronic brushes for electric motors, alternators, generators & aerospace, automotive, transportation brake pads, and Carbon and Carbon Nanotube CNTs precision casting molds for manufacturing of Super Alloy.

### BRIEF DESCRIPTION OF FIG. 1 DRAWING

FIG. 1 The Variable Hydraulic Preform Slurry Electrolyte Extrusion Carbon and Carbon Nanotube CNTs High Heat Wear Resistant Parts Press.

### DETAILED DESCRIPTION OF THE INVENTION

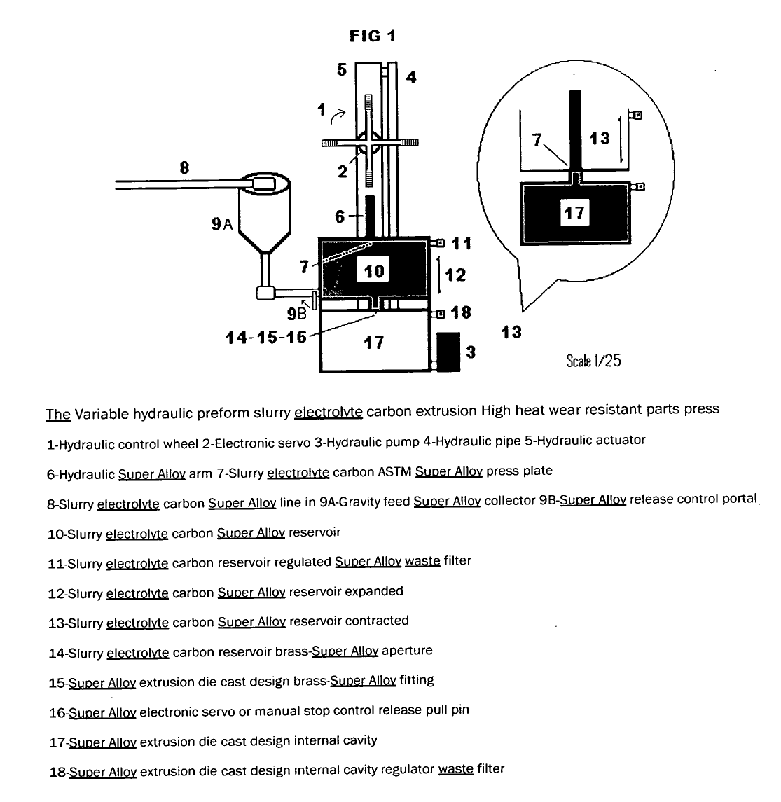

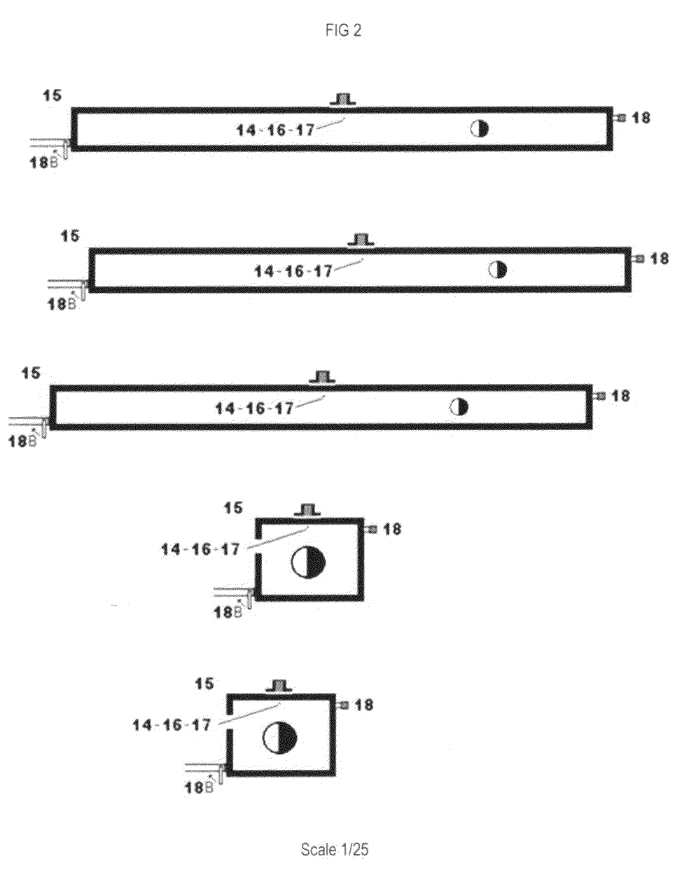

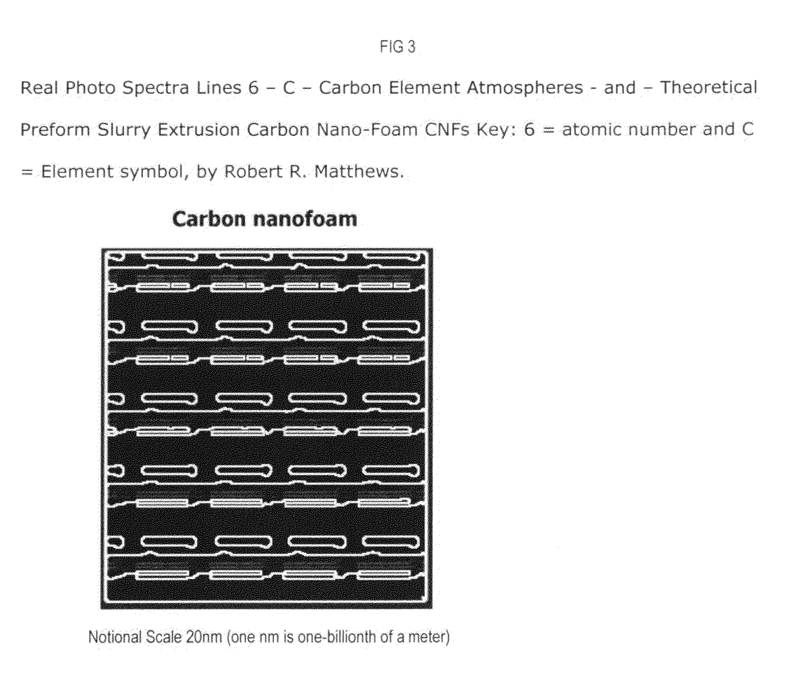

The Variable Hydraulic Preform Slurry Electrolyte Extrusion Carbon and Carbon Nanotube CNTs High Heat Wear Resistant Parts Press FIG. 1 Numbers 1 to 18 specific components conform to specified requirements to unique American Society for Testing and Materials ASTM International Standards Worldwide identifiers.

The 1—Hydraulic control wheel is connected to the 2—Electronic servo and allows the operator to expand and contract 7—Carbon Slurry ASTM Standard Press Plate primarily to expand the 10—Carbon slurry reservoir by moving the 1—Hydraulic control wheel in a fully counter clockwise fashion. This then allows the operator to initiate a separate machine to pump carbon slurry into the 8—Carbon Slurry Line in, subsequently to the 9—Gravity feed collector Line out and finally to the 10—Carbon slurry reservoir. After the 10—Carbon slurry reservoir is filled the operator can manually remove the 17—Steel extrusion die cast design manual stop release control. The operator would proceed by rotating the 1—Hydraulic control wheel in a clockwise fashion contracting The 7—Carbon-Slurry ASTM Standard Press Plate forces the composition of preform slurry electrolyte Carbon and Carbon Nanotube CNTs into the 15—Steel extrusion die cast design internal cavity. The operator then closes the 9B—Control to prepare for the extrusion. The specified amount of carbon slurry is compressed to specification numeric pressures until the specified carbon slurry required to fill the 15—Steel extrusion die cast design internal cavity has been reached. The 1—Hydraulic control wheel is then locked until the 15—Steel extrusion die cast design internal cavity has been removed.

The 2—Electronic servo sends an electrical signal to the 3—Hydraulic pump of the 7—Carbon Slurry ASTM Standard Press Plate position that is calibrated to the 1—Hydraulic control wheel.

The 3—Hydraulic pump receives an electrical signal from the 2—Electronic servo of the 7—Carbon Slurry ASTM Standard Press Plate position that is calibrated to the 1—Hydraulic control wheel. The 3—Hydraulic pump pumps fluids to the 4—Hydraulic pipe.

The 4—Hydraulic pipe receives fluids from the 3—Hydraulic pump and conveys the fluids to the 5—Hydraulic actuator.

The 5—Hydraulic actuator receives fluids from the 4—Hydraulic pipe and the force from the fluids is transferred through the actuator as vertical up-and-down movement to an affixed 6—Hydraulic arm.

The 6—Hydraulic arm moves vertically up-and-down and forces the 7—Carbon Slurry ASTM Standard Press Plate to expand and contract.

The 7—Carbon Slurry ASTM Standard Press Plate is forced by the 6—Hydraulic arm to expand and contract.

The 8—Carbon Slurry Line in receives slurry electrolyte Carbon and Carbon Nanotube CNTs from an external pump and conveys them to the 9A—Gravity feed collector.

The 9A—Gravity feed collector receives slurry electrolyte Carbon and Carbon Nanotube CNTs from the 8—Carbon Slurry Line in and conveys them to the 10—Carbon slurry reservoir.

The 9B—Gravity feed collector Control is utilized to close the 9B—Control to prepare for the extrusion.

The 10—Carbon slurry reservoir receives slurry electrolyte Carbon and Carbon Nanotube CNTs from the 9—Gravity feed collector Line out. After the 10—Carbon slurry reservoir is filled the 9B—Gravity feed collector Control is utilized to close the 9B—Control to prepare for the extrusion.

The 11—Carbon slurry reservoir regulated waste filter removes waste from the 10—carbon slurry reservoir while it is being filled with slurry electrolyte Carbon and Carbon Nanotube CNTs.

The 12—Carbon slurry reservoir expanded.

The 13—Carbon slurry reservoir contracted.

The 14—Carbon slurry reservoir aperture conveys slurry electrolyte Carbon and Carbon Nanotube CNTs to the 15—Steel extrusion die cast design internal cavity.

The 15—Steel extrusion die cast design internal cavity is specifically designed as a steel extrusion die cast mold for each preform slurry extrusion Carbon and Carbon Nanotube CNTs high heat wear resistant parts two extrusion steel halves for each part. This is accomplished utilizing the most advanced steel part manufacture process and machined steel part technique practice for the following parts 1. Preform slurry extrusion Carbon and Carbon Nanotube CNTs parts 2. Preform slurry extrusion Carbon and Carbon Nanotube CNTs high wear parts 3. Preform slurry extrusion Carbon and Carbon Nanotube CNTs high heat wear resistant parts 4. Preform slurry extrusion Carbon and Carbon Nanotube CNTs high heat wear resistant parts electronic brushes for electric motors, alternators, and generators 5. Preform slurry extrusion Carbon and Carbon Nanotube CNTs high heat wear resistant parts & aerospace, automotive, and transportation brake pads and 6. Preform slurry extrusion Carbon and Carbon Nanotube CNTs high heat wear resistant parts precision casting molds for manufacturing of Super Alloy specializing in up to 2.5 phase extrusion six carbon preform slurry extrusion Carbon and Carbon Nanotube CNTs high heat wear resistant parts precision casting molds. Preform slurry extrusion Carbon and Carbon Nanotube CNTs high heat wear resistant parts precision casting molds contrast from other preform slurry extrusion Carbon and Carbon Nanotube CNTs high heat wear resistant parts. Preform slurry extrusion Carbon and Carbon Nanotube CNTs high heat wear resistant parts precision casting molds requires six extrusion steel halves for each part. The Manufacture process of 2.5 phase extrusion precision casting and design for Super Alloy requires six master extrusion steel halves for each part allowing any two Super Alloy or metal to be combined Super Alloy layered alloying component aluminum, copper, silver, nickel, steel, ferro-tungsten, titanium and/or alloying component carbon nanotube CNTs, chromium, stainless, anodize nitride, or molybdenum. The 0.5 of 2.5 equals 2 of 6 extrusion steel halves. The Preform slurry extrusion Carbon and Carbon Nanotube CNTs high heat wear resistant parts half shells are utilized for state-of-the-art design to correct manufactured limitation when combining Super Alloy in layered foundry fills. The Super Alloy is a layered 2% to 98% Alloy A and 98% to 2% Alloy B part created in any layered foundry fill or combinations of fills by utilizing six carbon preform slurry extrusion Carbon and Carbon Nanotube CNTs high heat wear resistant parts precision casting molds by pouring molten metal as a layered alloying component Super Alloy foundry fill.

16—Steel extrusion die cast design aperture conveys slurry electrolyte Carbon and Carbon Nanotube CNTs to the 15—Steel extrusion die cast design internal cavity.

The 17—Steel extrusion die cast design manual stop release control can be manually removed after the 10—Carbon slurry reservoir is filled to begin the slurry electrolyte Carbon and Carbon Nanotube CNTs extrusion.

The 18—Steel extrusion die cast design internal cavity regulator waste filter removes waste from the 15—Steel extrusion die cast design internal cavity while it is being filled with slurry electrolyte Carbon and Carbon Nanotube CNTs.

The last step to manufacture process preform slurry electrolyte extrusion Carbon and Carbon Nanotube CNTs high heat wear resistant parts is to cure the parts in a furnace typically for 10 to 20 minutes from 1076 degrees Fahrenheit to 3230 Fahrenheit.

Specification Periodic Table Element Groups Alkali Metals, Alkalide Earth Metals, Transition Metals, Other Metals, Metalloids, Non-Metals, Halogens, Noble Gases, and Rare Earth Element here in atomic number, element symbols, and names 3—Li—Lithium, 4—Be—Beryllium, 5—B—Boron, 12—Mg—Magnesium, 13—Al—Aluminum, 21—Sc—Scandium, 22—Ti—Titanium, 23—V—Vanadium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 32—Ge—Germanium, 33—As—Arsenic, 37—Rb—Rubidium, 38—Sr—Strontium, 39—Y—Yttrium, 40—Zr—Zirconium, 41—Nb—Niobium, 42—Mo—Molybdenum, 43—Tc—Technetium, 44—Ru—Ruthenium, 45—Rh —Rhodium, 46—Pd—Palladium, 47—Ag—Silver, 48—Cd—Cadmium, 49—In—Indium, 50—Sn—Tin, 51—Sb—Antimony, 52—Te—Tellurium, 55—Cs—Cesium, 56—Ba—Barium, 57—La—Lanthanum, 58—Ce—Cerium, 59—Pr—Praseodymium, 60—Nd—Neodymium, 61—Pm—Promethium, 62—Sm—Samarium, 63—Eu—Europium, 64—Gd—Gadolinium, 65—Tb—Terbium, 66—Dy—Dysprosium, 67—Ho—Holmium, 68—Er—Erbium, 69—Tm—Thulium, 70—Yb—Ytterbium, 71—Lu—Lutetium, 72—Hf—Hafnium, 73—Ta—Tantalum, 74—W—Tungsten, 75—Re—Rhenium, 76—Os—Osmium, 77—Ir—Iridium, 78—Pt—Platinum, 79—Au—Gold, 80—Hg—Mercury, 81—Tl—Thallium, 82—Pb—Lead, 83—Bi—Bismuth, 84—Po—Polonium, 85—At—Astatine, 87—Fr—Francium, 88—Ra—Radium, 89—Ac—Actinium, 90—Th—Thorium, 91—Pa—Protactinium, 92—U—Uranium, 93—Np—Neptunium, 94—Pu—Plutonium, 95—Am—Americium, 96—Cm—Curium, 97—Bk—Berkelium, 98—Cf—Californium, 99—Es—Einsteinium, 100—Fm—Fermium, 101—Md—Mendelevium, 102—No—Nobelium, 103—Lr—Lawrencium, 104—Rf—Rutherfordium, 105—Db—Dubnium, 106—Sg—Seaborgium, 107—Bh—Bohrium, 108—Hs—Hassium, 109—Mt—Meitnerium, 110—Ds—Darmstadtium, 111—Rg—Roentgenium, 112—Cn—Copernicium, 113—Uut—Ununtrium, 114—Uuq—Ununquadium, 115—Uup—Ununpentium, 116—Uuh—Ununhexium, 117—Uus—Ununseptium, and/or 118—Uuo—Ununoctium.

Specification Alloys metallurgy substances that are a mixture of two or more metals, or of a metal with a nonmetallic material not limited to Aluminum Alloys AA-8000 used for building wire; Al—Li aluminum, lithium, sometimes mercury; Alnico aluminum, nickel, copper; Duralumin copper, aluminum; Magnalium aluminum, 5% magnesium; Magnox magnesium oxide, aluminum; Nambe aluminum plus seven other unspecified metals; Silumin aluminum, silicon; and Zamak zinc, aluminum, magnesium, copper; Aluminum forms other complex alloys with magnesium, manganese, and platinum. Bismuth Alloys Wood's metal bismuth, lead, tin, cadmium; Rose metal bismuth, lead, tin; Field's metal; and Cerrobend. Cobalt Alloys Megallium; and Stellite cobalt, chromium, tungsten or molybdenum, carbon Talonite cobalt, chromium. Ultimet cobalt, chromium, nickel, molybdenum, iron, tungsten; and Vitallium. Copper Alloys Arsenical copper; Beryllium copper, beryllium; and Billon copper, silver. Brass copper, zinc; Calamine brass copper, zinc; Chinese silver copper, zinc; Dutch metal copper, zinc; Gilding metal copper, zinc; Muntz metal copper, zinc; Pinchbeck copper, zinc; Prince's metal copper, zinc; and Tombac copper, zinc. Bronze copper, tin, aluminum or other element; Aluminum bronze copper, aluminum; Arsenical bronze copper, arsenic; Bell metal copper, tin; Florentine bronze copper, aluminum or tin; Glucydur beryllium, copper, iron; Guanin likely a manganese bronze of copper, manganese, with iron sulfides and other sulfides; Gunmetal copper, tin, zinc; Phosphor bronze copper, tin and phosphorus; Ormolu Gilt Bronze copper, zinc; and Speculum metal copper, tin. Constantan copper, nickel; Copper-tungsten copper, tungsten; Corinthian bronze copper, gold, silver; Cunife copper, nickel, iron; Cupronickel copper, nickel; Cymbal alloys Bell metal copper, tin; Devarda's alloy copper, aluminum, zinc; Electrum copper, gold, silver; Hepatizon copper, gold, silver; Heusler alloy copper, manganese, tin; Manganin copper, manganese, nickel; Nickel silver copper, nickel; Nordic gold copper, aluminum, zinc, tin; Shakudo copper, gold; and Tumbaga copper, gold. Gallium Alloys Galinstan gallium, indium, tin. Gold Alloys Electrum gold, silver, copper; Tumbaga gold, copper; Rose gold, copper; and White gold, nickel, palladium, or platinum. Indium Alloys Field's metal indium, bismuth, tin. Iron or Ferrous Alloys Steel carbon Stainless steel chromium, nickel; AL-6XN; Alloy 20; Celestrium; Marine grade stainless; Martensitic stainless steel; and Surgical stainless steel chromium, molybdenum, nickel. Silicon steel silicon; Tool steel tungsten or manganese; Bulat steel; Chromoly chromium, molybdenum; Crucible steel; Damascus steel; HSLA steel; High speed steel; Maraging steel; Reynolds 531; and Wootz steel. Iron Anthracite iron carbon; Cast iron carbon; Pig iron carbon; and Wrought iron carbon. Fernico nickel, cobalt; Elinvar nickel, chromium; Invar nickel; Kovar cobalt; and Spiegeleisen manganese, carbon, silicon. Ferroalloys Ferroboron; Ferrochrome chromium; Ferromagnesium; Ferromanganese; Ferromolybdenum; Ferronickel; Ferrophosphorus; Ferrotitanium; Ferrovanadium; and Ferrosilicon. Lead Alloys Antimonial lead, antimony; Molybdochalkos lead, copper; Solder lead, tin; Terne lead, tin; and Type metal lead, tin, antimony. Magnesium Alloys Magnox magnesium, aluminum T—Mg—Al—Zn Bergman phase; and Elektron. Mercury Alloys Amalgam mercury and other metal except platinum. Nickel Alloys Alumel nickel, manganese, aluminum, silicon; Chromel nickel, chromium; Cupronickel nickel, bronze, copper; German silver nickel, copper, zinc; Hastelloy nickel, molybdenum, chromium, sometimes tungsten; Inconel nickel, chromium, iron; Monel metal copper, nickel, iron, manganese; Mu-metal nickel, iron; Ni—C nickel, carbon; Nichrome chromium, iron, nickel; Nicrosil nickel, chromium, silicon, magnesium; Nisil nickel, silicon; and Nitinol nickel, titanium, shape memory alloy. Potassium Alloys KLi potassium, lithium; and NaK sodium, potassium. Rare Earth Alloys Mischmetal various rare earths. Silver Alloys Argentium sterling silver, copper, germanium; Billon copper or copper bronze, sometimes with silver; Britannia silver, copper; Electrum silver, gold; Goloid silver, copper, gold; Platinum sterling silver, platinum; Shibuichi silver, copper; and Sterling silver, copper. Tin Alloys Britannium tin, copper, antimony; Pewter tin, lead, copper; and Solder tin, lead, antimony. Titanium Alloys Beta C titanium, vanadium, chromium, other metals; and 6al-4v titanium, aluminum, vanadium. Uranium Alloys Staballoy depleted uranium with titanium or molybdenum; and Uranium may also be alloyed with plutonium. Zinc Alloys Brass zinc, copper; and Zamak zinc, aluminum, magnesium, copper. Zirconium Alloys Zircaloy zirconium and tin, sometimes with niobium, chromium, iron, nickel.

1. Manufacture process of preform slurry electrolyte extrusion Carbon and Carbon Nanotube CNTs high heat wear resistant parts 1. Preform slurry extrusion Carbon and Carbon Nanotube CNTs parts 2. Preform slurry extrusion Carbon and Carbon Nanotube CNTs high wear parts 3. Preform slurry extrusion Carbon and Carbon Nanotube CNTs high heat wear resistant parts 4. Preform slurry extrusion Carbon and Carbon Nanotube CNTs high heat wear resistant parts electronic brushes for electric motors, alternators, and generators 5. Preform slurry extrusion Carbon and Carbon Nanotube CNTs high heat wear resistant parts & aerospace, automotive, and transportation brake pads and 6. Preform slurry extrusion Carbon and Carbon Nanotube CNTs high heat wear resistant parts precision casting molds for manufacturing of Super Alloy specializing in up to 2.5 phase extrusion six carbon preform slurry extrusion Carbon and Carbon Nanotube CNTs high heat wear resistant parts and numeric foundry fill pours for casings electric motors, alternators, generators and high wear resistant parts bearings, housings, casings, airframe, flight controls, turbine blades ETC.

2. Manufacture process The Variable Hydraulic Preform Slurry Electrolyte Extrusion Carbon and Carbon Nanotube CNTs High Heat Wear Resistant Parts Press FIG. 1 Numbers 1 to 18 making and using the same specific parts that conform to specified requirements to unique American Society for Testing and Materials ASTM International Standards Worldwide identifiers as making and using the same as the specification.
